(19) United States
(12) Patent Application Publication
(10) Pub. No.: US 2014/0369476 A1
(43) Pub. Date: Dec. 18, 2014

(54) DEVICE FOR GENERATING X-RAYS HAVING A LIQUID METAL ANODE

(71) Applicant: Morpho Detection, Inc., Newark, CA (US)

(72) Inventor: Geoffrey Harding, Hamburg (DE)

(21) Appl. No.: 13/918,171

(22) Filed: Jun. 14, 2013

(51) Int. Cl. H01J 35/08; H01J 35/12

(52) U.S. Cl. CPC H01J 35/08; H01J 35/12
USPC 378/140; 378/143

(57) ABSTRACT

A device for generating X-rays includes at least one electron source for the emission of an electron beam that defines a plane having a predetermined width value in a width dimension and a predetermined length value in a length dimension. The width dimension is substantially perpendicular to the length dimension. The device also includes at least one window frame at least partially defining at least one liquid metal flow path. The device further includes at least one electron window coupled to the at least one window frame. The at least one electron window is positioned within the at least one liquid metal flow path and is configured to receive the electron beam. The at least one electron window emits X-rays in response to an incidence of electrons thereon. The at least one electron window includes a surface curved in at least one of the width dimension and the length dimension.

### BACKGROUND OF THE INVENTION

The embodiments described herein relate generally to a device for generating X-rays and, more particularly, to an anode module for a liquid-metal anode X-ray (LIMAX) source including a curved electron window.

At least some known X-ray devices use a liquid-metal anode to generate X-ray beams that generate photons for X-ray diffraction imaging (XDI). This technique is called LIMAX (liquid-metal anode X-ray). When generating X-ray beams, the liquid-metal anode is bombarded with an electron beam generated by a cathode through an electron window that defines a region of electron focus. Many known electron windows include a thin metal foil or a diamond film which is so thin that the electrons lose only a small part of their kinetic energy therein. Therefore, a significant portion of the kinetic energy of the electrons is deposited in the liquid-metal anode at the focus region and waste heat is generated. As a result, the liquid-metal anode tends to increase in temperature and the heat generated is removed from the region of electron focus in order that the liquid-metal anode does not exceed temperature parameters. The mechanisms of heat transfer using the liquid metal include convection with at least some turbulent mass transport, conduction, and electron diffusion processes. The liquid metal receives the heat generated within the anode and is circulated through a circuit that includes a fluid transport device and a heat exchange device.

The detection performance of XDI, as expressed in such parameters as false alarm rate (FAR) and detection rate, improves as the number of photons acquired in a measurement increases such that photon noise decreases proportionately. In order to increase the number of detected photons while maintaining a predetermined measurement time constant, it is necessary to increase the radiance of the radiation source, i.e., increase values of emitted photons per second, per steradian, per unit projected source area. Such increased radiance is achieved by increasing the power density of the electron beam deposited in the stationary anode. However, many of such known X-ray devices are limited in the strength of the X-ray beam due to the limitations associated with the heat transfer devices used to remove the heat generated in the anode. Such limitations include the structural integrity of the liquid-metal anode as a function of the upward scalability the X-ray systems. For example, an electron window portion of the anode is a metal foil having a thickness on the order of tens of microns subject to degradation and mechanical instability. As the power density of the X-ray device increases, the structural integrity of the electron window portion of the liquid-metal anode must increase.

### BRIEF DESCRIPTION OF THE INVENTION

In one aspect, a device for generating X-rays is provided. The device includes at least one electron source for the emission of an electron beam that defines a plane having a predetermined width value in a width dimension and a predetermined length value in a length dimension. The width dimension is substantially perpendicular to the length dimension. The device also includes at least one window frame at least partially defining at least one liquid metal flow path. The device further includes at least one electron window coupled to the at least one window frame. The at least one electron window is positioned within the at least one liquid metal flow path and is configured to receive the electron beam. The at least one electron window emits X-rays in response to an incidence of electrons thereon. The at least one electron window includes a surface curved in at least one of the width dimension and the length dimension.

In another aspect, an anode module for a liquid-metal anode X-ray (LIMAX) source is provided. The anode module includes a window frame at least partially defining at least one liquid metal flow path and an electron window coupled to the window frame. The electron window is positioned within the liquid metal flow path and is configured to receive the electron beam. The electron window is configured to emit X-rays in response to an incidence of electrons thereon. The electron window includes a surface curved in at least one dimension. The electron beam defines a plane having a predetermined width value in a width dimension and a predetermined length value in a length dimension. The width dimension is substantially perpendicular to the length dimension.

### BRIEF DESCRIPTION OF THE DRAWINGS

FIGS. 1-3 show exemplary embodiments of the systems and methods described herein.

FIG. 1 is a schematic cross-sectional side view of an exemplary device for generating X-rays;

FIG. 2 is a schematic cross-sectional side view of an exemplary anode module that may be used with the device shown in FIG. 1 and taken at area 2; and

FIG. 3 is a schematic perspective view of an exemplary electron window that may be used with the anode module shown in FIG. 2 and taken at area 3.

### DETAILED DESCRIPTION OF THE INVENTION

The anode module for an X-ray device that includes a liquid-metal anode X-ray (LIMAX) source provides a cost-effective method for generating X-rays. Specifically, the LIMAX source includes an anode module that includes a curved electron window configured with a surface curved in two dimensions to define a substantially hyperbolic paraboloid surface. More specifically, the surface curves are configured to receive an electron beam emitted by an electron source. The electron beam defines a plane having a predetermined width value and a predetermined length value, the width dimension perpendicular to the length dimension. The embodiments described herein include the curved electron window coupled to a window frame such that they cooperate to define a liquid metal flow path. The electron window, in conjunction with the liquid metal, emits X-rays in response to an incidence of electrons thereon. The curved electron window facilitates increased heat transfer into the liquid metal stream to cool the electron window by inducing turbulent flow of the liquid metal and facilitating an associated increase in mechanical stability. Therefore, the embodiments described herein enhance performance of X-ray devices by facilitating an increased electron flux, and the subsequent increased X-ray flux, thereby decreasing the potential for false alarms and decreasing the false alarm rate.

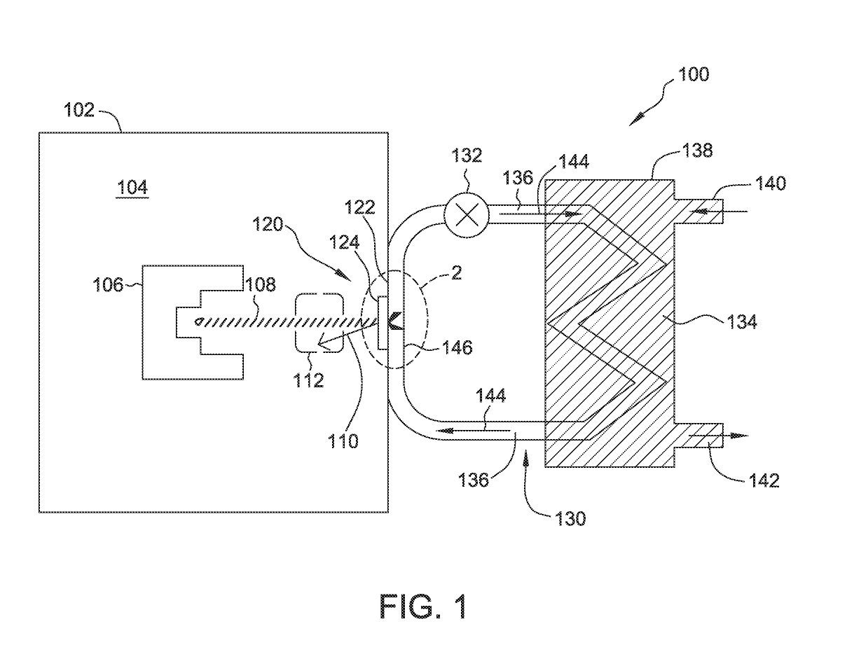

FIG. 1 is a schematic cross-sectional side view of an exemplary device 100 for generating X-rays (not shown in FIG. 1). In the exemplary embodiment, X-ray device 100 is a liquid-metal anode X-ray (LIMAX) device. X-ray device 100 includes an X-ray tube 102 that is fabricated from any material and under a vacuum of any pressure less than atmospheric that enables operation of X-ray device 100 as described herein. X-ray tube 102 defines a tube cavity 104. X-ray device 100 also includes a cathode 106 that generates an electron beam 108 within the vacuum of tube cavity 104. Electron beam 108 facilitates generation of an X-ray beam 110 that exits X-ray device 100 through an X-ray emission window 112 defined in X-ray tube 102. X-ray emission window 112 is substantially transparent to X-ray beam 110 and has sufficient structural integrity to facilitate maintaining the vacuum pressures in X-ray tube 102.

X-ray device 100 further includes an anode module 120 that defines a window frame 122 as a portion of X-ray tube 102. Anode module 120 also includes an electron window 124 coupled to window frame 122. Electron window 124 is fabricated from any material that enables operation of X-ray device 100 as described herein, including, without limitation, tungsten (wolfram) due to its high atomic number of 74, good thermal conductivity, and high melting point. However, due to the brittle nature of tungsten, it may be alloyed with other materials to produce, e.g., without limitation, tungsten rhenium (WRe), or, for greater strength over a greater temperature range, with hafnium carbide (HfC) to produce WRe/HfC. Electron window 124 has sufficient structural integrity to facilitate maintaining the vacuum pressures in X-ray tube 102.

X-ray device 100 also includes a closed-circuit liquid-metal circulation system 130 that includes a pumping device 132 and a heat exchange device 134 coupled in flow communication with each other and anode module 120 through a plurality of liquid-metal conduits 136. In the exemplary embodiment, heat exchange device 134 is a shell-and-tube heat exchanger that includes a casing 138 that defines a secondary cooling fluid inlet 140 and outlet 142. Casing 138 and channels 140 and 142 facilitate channeling a secondary cooling fluid (not shown), e.g., without limitation, air and water, over liquid-metal conduits 136 within heat exchange device 134. Heat is transferred from the liquid metal in conduits 136 to the secondary cooling fluid. Alternatively, heat exchange device 134 is any device that enables operation of X-ray device 100 as described herein. Flow of liquid metal is designated by arrows 144. Alternatively, the flow of liquid metal may be in the opposite direction. Liquid metal stream 144 acts as beam dump for those electrons that have lost an appreciable fraction of their initial energy in electron window 124. In the exemplary embodiment, anode module 120 includes a portion 146 of liquid-metal conduit 136 upstream of pumping device 132 and downstream of heat exchange device 134. Also, in the exemplary embodiment, portion 146 of liquid-metal conduit 136, window frame 122, and electron window 124 cooperate to channel liquid metal stream 144 through anode module 120.

In operation, electron beam 108 is generated by cathode 106 within the vacuum of tube cavity 104 and is transmitted toward anode module 120. Electron beam 108 impinges electron window 124 and a first portion of electrons imparts at least some kinetic energy therein. Most of these electrons continue to traverse electron window 124. A second, much greater, portion of electron beam 108 is transmitted through electron window 124 without interaction therein into liquid metal stream 144. The interaction of the relatively small first portion of the electrons in beam 108 with electron window 124 and the relatively large second portion of the electrons in beam 108 passing through window 124 to interact with liquid metal 144 generates X-ray radiation in the form of X-ray beam 110, i.e., liquid metal 144 acts as a target. X-ray beam 110 exits X-ray device 100 through X-ray emission window 112. The interaction of electron beam 108 with electron window 124 and liquid metal 144 also generates heat in both electron window 124 and liquid metal 144 that is removed from electron window 124 by liquid metal 144 as it is circulated through liquid-metal circulation system 130.

In the exemplary embodiment, a single electron beam interacts with a single electron window to generate a single X-ray beam. However, at least some alternative embodiments include a plurality of electron windows to generate a plurality of X-ray beams, thereby defining a LIMAX multisource system. More specifically, portions of LIMAX device 100, i.e., anode module 120 including electron window 124 and at least portion 146 of liquid-metal circulation system 130 may be replicated to accommodate applications requiring an X-ray multisource. As such, each electron window 124 and associated portion 146 of liquid-metal circulation system 130 is located at the site of an X-ray focus and is sequentially addressed by electron beam 108. Multiple inverse fan beam geometry is one example of an application requiring an X-ray multisource. Thus an anode structure including a plurality of electron windows 124 and associated portions 146 is suited for enabling X-ray diffraction imaging (XDI) systems with a LIMAX multisource system.

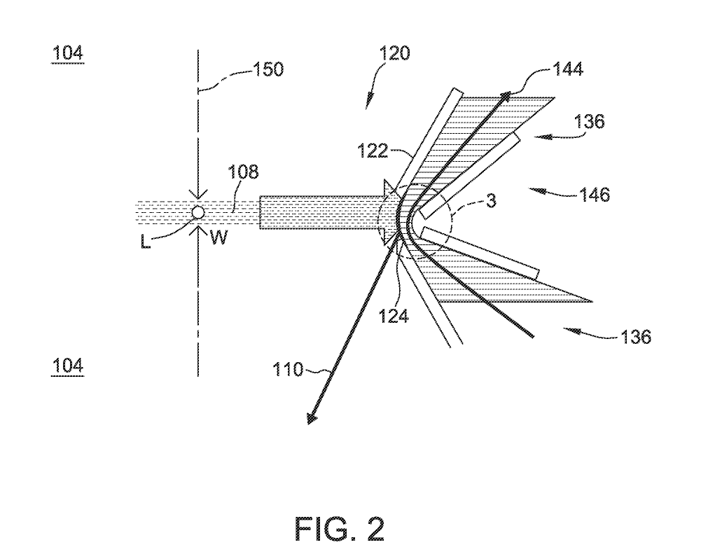

FIG. 2 is a schematic cross-sectional side view of anode module 120 that may be used with X-ray device 100 (shown in FIG. 1 and taken along area 2). Electron beam 108 is oriented and configured to define a plane 150 having a predetermined width value W and a predetermined length value L, the width dimension perpendicular to the length dimension. Plane 150 and length L are shown in FIG. 2 as entering and exiting the page orthogonally.

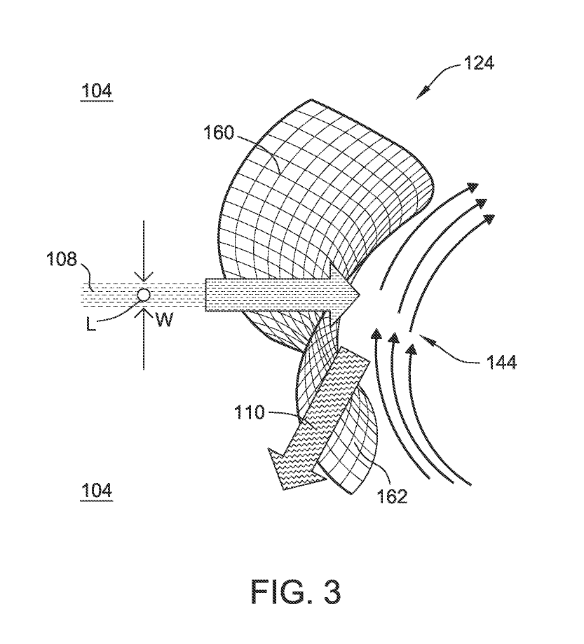

FIG. 3 is a schematic perspective view of electron window 124 that may be used with anode module 120 (shown in FIG. 2 and taken at area 3). In the exemplary embodiment, electron window defines a plurality of surfaces, i.e., a vacuum side surface 160 and a coolant side surface 162. Each of surfaces 160 and 162 are curved in at least one dimension, and in the exemplary embodiment, curved in two directions to define two-dimensional (2D) substantially hyperbolic paraboloid surfaces 160 and 162.

Coolant side surface 162 defines a first radius of curvature in a first direction substantially coincident with the direction of flow of a liquid-metal 144 across electron window 124. Also, the first radius of curvature of surface 162 is a function of width W of electron beam 108 in the first direction and an electron range of electron beam 108 in electron window 124 as described further below.

In general, the primary function of electron window 124 is to convert electron energy into X-rays through electron impact with electron window 124 and liquid metal 144. This conversion process is enhanced for a window material having a relatively high atomic number. Tungsten, with an atomic number of 74, and its alloys are often used for electron-to-X-ray conversion. For small values of window thickness, the x-ray yield increases linearly with window thickness.

However, for moderate values of window thickness, the x-ray yield gradually becomes independent of thickness. This is due to at least some electrons that survive to greater depths in the window losing so much kinetic energy that they are inefficient at X-ray production. Moreover, those X-rays produced at significant depths in the window are significantly attenuated. Therefore, for thicker windows, the X-ray yield approaches a limit, i.e., the X-ray yield saturates. In addition, energy absorption from the electron beam within the window increases with increased window thickness and also increases the temperature gradient between the two surfaces of the window. As such, further increasing of window thickness does not improve the X-ray yield, but instead, facilitates decreasing a margin to the thermal limits of the X-ray tube. Therefore, a preferred electron window thickness is achieved in a range between approximately 25% and approximately 50% of the electron range. For an electron beam of approximately 250 kiloelectron-volts (keV) in tungsten, the electron range is approximately 50 micrometers (μm). Hence, a tungsten metal foil electron window within a thickness range between approximately 12 μm and approximately 25 μm is preferred. Given such a thickness range for the electron window foil, most of the electrons incident on the metal foil will diffuse, albeit with reduced energy, through the foil and into the liquid metal stream.

In order to enhance the extraction of X-rays from the liquid metal source medium, the electron window radius R should be sufficiently large that the configuration of the X-ray target approximates to a planar body with respect to the electron beam. The electron beam, when it irradiates the target, causes X-rays to be emitted from a volume of material having a depth δ, equivalent to the electron range, a width W, equal to the width of the electron beam, and a length L, in the dimension of the electron beam perpendicular to its width. In a typical case, δ is approximately 50 μm, W is approximately 2 millimeters (mm), and L is approximately 5 mm. As such, an approximation of the radius of curvature in the flow direction when the curved electron window can be considered to be planar such that the deviation from planarity is less than the electron range may be made according to the equation:

R_{Flow}≧W²/(8*δ) Equation 1

Inserting values of the relevant parameters in Equation 1 leads to the conclusion that the radius of curvature of the electron window in the flow direction should be at least 10 mm.

Coolant side surface 162 also defines a second radius of curvature in a second direction substantially perpendicular to the first direction, i.e., perpendicular to the direction of flow of a liquid-metal 144 across electron window 124. Also, the second radius of curvature of surface 162 is a function of the determined radius of curvature of the electron window in the flow direction, i.e., R_{Flow} as determined above, width W of electron beam 108 in the first direction, and length L in the perpendicular direction as described further below.

The radius of curvature, R_{P}, of the electron window in the length direction of the electron beam is given by the following equation (the electron range, δ, is substantially constant):

R_{P}≈R_{Flow}*(L/W)² Equation 2

From the above dimensions, R_{P} should be greater than or equal to 62.5 mm.

The above described anode module for an X-ray device that includes a liquid-metal anode X-ray (LIMAX) source provides a cost-effective method for generating X-rays. Specifically, the LIMAX source includes an anode module that includes a curved electron window configured with a surface curved in two dimensions to define a substantially hyperbolic paraboloid surface. More specifically, the 2D radii of curvature of the hyperbolic paraboloid facilitate increasing mechanical stability and additionally facilitate cooling through promotion of turbulence. The curvatures facilitate accommodating induced forces on the electron window as a function of the pressures associated with liquid metal flow, i.e., the tendency to bulge in existing curved surfaces is significantly reduced. Also, centrifugal forces acting on the liquid metal flowing around a curve promote vortex production, and thus enhance turbulent flow near the electron window. Turbulence promotion is beneficial for improving the thermal convection coefficient and thus for increasing the flow of heat from the electron window into the liquid metal stream. Also, limiting the thickness of the electron window and direct cooling thereof with liquid metal reduces the differential thermal expansion and associated thermal stresses therein. These beneficial characteristics facilitate extending the useful service life of X-ray devices. Also, as such, the X-ray systems described herein facilitate higher power densities. In addition, such XDI systems will facilitate much higher power densities than can be achieved with X-ray multisources featuring conventional stationary anodes. Therefore, the embodiments described herein enhance performance of X-ray devices by facilitating an increased electron flux, and the subsequent increased X-ray flux, thereby decreasing the potential for false alarms and decreasing the false alarm rate.

A technical effect of the systems and methods described herein includes at least one of: (a) increased mechanical stability of electron windows; (b) promotion of turbulent heat transfer to remove heat from electron windows; and (c) increased power density of X-ray multisource devices.

Exemplary embodiments of LIMAX systems are described above in detail. The systems are not limited to the specific embodiments described herein, but rather, components of systems may be utilized independently and separately from other components described herein. For example, the systems may also be used in combination with other detection systems, and are not limited to practice with only the detection systems as described herein. Rather, the exemplary embodiment may be implemented and utilized in connection with other X-ray system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device for generating X-rays comprising:
at least one electron source for the emission of an electron beam that defines a plane having a predetermined width value in a width dimension and a predetermined length value in a length dimension, the width dimension substantially perpendicular to the length dimension;
at least one window frame at least partially defining at least one liquid metal flow path; and
at least one electron window coupled to said at least one window frame, said at least one electron window positioned within said at least one liquid metal flow path and configured to receive the electron beam, said at least one electron window emits X-rays in response to an incidence of electrons thereon, wherein said at least one electron window comprises a surface curved in at least one of the width dimension and the length dimension.

2. The device in accordance with claim 1, wherein said surface curved in at least one dimension comprises a substantially hyperbolic paraboloid surface.

3. The device in accordance with claim 2, wherein said substantially hyperbolic paraboloid surface defines a first radius of curvature in a first direction, said first radius of curvature being a function of the width of the electron beam in the first direction and an electron range of the electron beam in said at least one electron window.

4. The device in accordance with claim 3, wherein said substantially hyperbolic paraboloid surface further defines a second radius of curvature in a second direction substantially perpendicular to the first direction, said second radius of curvature being a function of the length of the electron beam and an electron range of the electron beam in said at least one electron window.

5. The device in accordance with claim 3 further comprising a liquid-metal circulation system, wherein the first direction is substantially the direction of flow of a liquid-metal across said at least one electron window.

6. The device in accordance with claim 5, wherein said liquid-metal circulation system is a closed circuit comprising a heat removal device and a fluid transport apparatus.

7. The device in accordance with claim 5, wherein said liquid-metal circulation system is configured to remove heat from said at least one electron window.

8. The device in accordance with claim 5, wherein said at least one electron window is configured to induce turbulent flow of the liquid metal, thereby enhancing heat transfer from said at least one electron window.

9. The device in accordance with claim 1, wherein said at least one electron window has a thickness within a range between approximately 25% and approximately 50% of an electron range at least partially defined by said at least one electron window.

10. The device in accordance with claim 9, wherein said at least one electron window is fabricated from tungsten, the electron beam includes electrons having an energy of approximately 250 kilo-electron-Volts (keV), the electron range is approximately 50 micrometers (μm), and the thickness of said at least one electron window is within a range between approximately 12 μm and approximately 25 μm.

11. An anode module for a liquid-metal anode X-ray (LIMAX) source, said anode module comprising:
a window frame at least partially defining at least one liquid metal flow path; and
an electron window coupled to said window frame, said electron window positioned within said liquid metal flow path and configured to receive the electron beam, said electron window configured to emit X-rays in response to an incidence of electrons thereon, wherein said electron window comprises a surface curved in at least one dimension, the electron beam that defines a plane having a predetermined width value in a width dimension and a predetermined length value in a length dimension, the width dimension substantially perpendicular to the length dimension.

12. The anode module in accordance with claim 11, wherein said surface curved in at least one direction comprises a substantially hyperbolic paraboloid surface.

13. The anode module in accordance with claim 12, wherein said substantially hyperbolic paraboloid surface defines a first radius of curvature in a first direction, said first radius of curvature being a function of the width of the electron beam in the first direction and an electron range of the electron beam in said electron window.

14. The anode module in accordance with claim 13, wherein said substantially hyperbolic paraboloid surface further defines a second radius of curvature in a second direction substantially perpendicular to the first direction, said second radius of curvature being a function of the length of the electron beam and an electron range of the electron beam in said electron window.

15. The anode module in accordance with claim 13, wherein the first direction is substantially the direction of flow of liquid-metal across said electron window.

16. The anode module in accordance with claim 15, wherein said electron window is configured to transfer heat to the liquid metal.

17. The anode module in accordance with claim 15, wherein said electron window is configured to induce turbulent flow of the liquid metal, thereby enhancing heat transfer from said electron window.

18. The anode module in accordance with claim 11, wherein said electron window has a thickness within a range between approximately 25% and approximately 50% of an electron range at least partially defined by said electron window.

19. The anode module in accordance with claim 18, wherein said electron window is fabricated from tungsten and is configured to be impinged with an electron bean that includes electrons having an energy of approximately 250 kilo-electron-Volts (keV), wherein the electron range within said electron window is approximately 50 micrometers (μm), and the thickness of said electron window is within a range between approximately 12 μm and approximately 25 μm.

20. The anode module in accordance with claim 11 further comprising at least a portion of a liquid-metal conduit that cooperates with said window frame and said electron window to channel a liquid-metal stream through said anode module.
